(19) United States
(12) Patent Application Publication
(10) Pub. No.: US 2007/0230049 A1
(43) Pub. Date: Oct. 4, 2007

(54) Thin film device

(75) Inventors: Toshiyasu Fujiwara, Tokyo (JP); Kyung-Ku Choi, Tokyo (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/725,444

(22) Filed: Mar. 20, 2007

(30) Foreign Application Priority Data
Mar. 31, 2006 (JP) 2006-098576

(51) Int. Cl. G11B 5/147; G11B 5/17

(52) U.S. Cl. 360/126; 360/123

(57) ABSTRACT

A thin film device is provided which is capable of improving a Q value when employing a thin film coil wound on a magnetic film. In the thin film coil wound on an upper magnetic film, the thickness (TA) of lower coil portions in between a lower magnetic film and the upper magnetic film is larger than the thickness (TB) of upper coil portions not in between the lower and upper magnetic films (the thickness ratio TB/TA<1). The crossover magnetic flux crossing over the first coil portions in between the first and the second magnetic films can be reduced than the case where the thickness (TA) of the lower coil portions is equal to or less than the thickness (TB) of the upper coil portions (the thickness ratio TB/TA≧1).

### BACKGROUND OF THE INVENTION

1. Field of the Invention

The present invention relates to a thin film device having a thin film coil wound on a magnetic film.

2. Description of the Related Art

In the field of electronic equipments for various purposes, a thin film device with a thin film coil has been widely used in the recent years. As an example of the thin film device, there is a thin film inductor that is a circuit element having inductance.

As the shape of a thin film coil mounted on a thin film device, spiral type has been employed to meet the requirements of miniaturization (reduction in the area of a device) and low back (reduction in the thickness of the device). On the other hand, solenoid type has been employed for the purposes where the performance improvement is also required in addition to miniaturization and low back (for example, refer to Japanese Unexamined Patent Publication No. 05-029146). In the thin film device having the thin film coil of solenoid type, an exciting conductor is disposed around a thin film magnetic body (a magnetic core) in the shape of solenoid. This enables the inductance to be increased than the case of having a thin film coil of spiral type.

As the thin film coil of solenoid type, there is known one having the configuration divided into a plurality of parts (for example, refer to Japanese Unexamined Patent Publication No. 2004-296816). The thin film coil can be attained by connecting first and second coil conductors, which are formed on one surface and the other surface of a magnetic insulating substrate, respectively, to a connecting conductor formed at a penetration penetrating through the magnetic insulting substrate. The first and the second coil conductors have the same thickness to equalize direct current resistance.

### SUMMARY OF THE INVENTION

Although the thin film device of the related art having the thin film coil of solenoid type fulfills the requirements of miniaturization and low back, it cannot conclude that the thin film device fulfills the requirement of performance improvement for use in high frequency. In order to achieve the performance improvement of the thin film device for use in high frequency, it is required to improve a Q value that is an important characteristic of coils. The Q value is an index indicating quantitatively the performance of coils mounted on resonant circuits or the like. In general, the Q value can be expressed by the following definition expression: Q=ωL/R (where ω, L, and R are angular velocity, inductance, and resistance in measured frequency, respectively).

In view of the foregoing, it is desirable to provide a thin film device capable of improving the Q value when employing a thin film coil wound on a magnetic film.

According to an embodiment of the present invention, there is provided a thin film device having a first magnetic film and a second magnetic film oppositely disposed to each other, and a thin film coil wound on the second magnetic film. The thin film coil includes a plurality of first coil portions arranged between the first and the second magnetic films, a plurality of second coil portions arranged on a side opposite the first coil portions, with the second magnetic film interposed therebetween, and a plurality of third coil portions connecting the first and the second coil portions so that the first, second and third coil portions are combined together in series to form the thin film coil. The first coil portions have a larger thickness than the second coil portions.

On the thin film device, in the thin film coil wound on the second magnetic film, the thickness of the first coil portions in between the first and the second magnetic films is larger than the thickness of the second portions not in between the first and the second magnetic films. Therefore, the crossover magnetic flux crossing over the first coil portions in between the first and the second magnetic films can be reduced than the case where the thickness of the first coil portions is equal to or less than that of the second coil portions.

Preferably, one end or the other end in the longitudinal direction of the second coil portion is located so as to overlap with one end or the other end in the longitudinal direction of the first coil portion, and the third coil portion is arranged in a position where the second coil portion overlaps with the first coil portion. Especially, it is preferable that a ratio of a thickness TB of the second coil portions to a thickness TA of the first coil portions, namely TB/TA, is in a range of: 0.1<TB/TA<1.

In accordance with the thin film device of the present invention, in the thin film coil wound on the second magnetic film, the thickness of the first coil portions is larger than the thickness of the second portions. This enables the Q value to be improved than the case where the thickness of the first coil portions is equal to or less than that of the second coil portions. In this case, for example, by setting the ratio of the thickness TB of the second coil portions to the thickness TA of the first coil portions, namely TB/TA, to a range of 0.1<TB/TA<1, a sufficient Q value can be attained while suppressing an increase in the direct current resistance of the thin film coil.

Other and further objects, features and advantages of the invention will appear more fully from the following description.

### BRIEF DESCRIPTION OF THE DRAWINGS

FIG. 1 is a plan view showing a plan configuration of a thin film inductor as an application of a thin film device according to an embodiment of the present invention;

FIG. 2 is a sectional view showing a sectional configuration of the thin film inductor taken along the line II-II in FIG. 1;

FIG. 3 is a sectional view showing a sectional configuration of the thin film inductor taken along the line III-III in FIG. 1;

FIG. 4 is a sectional view showing a sectional configuration of the thin film inductor taken along the line IV-IV in FIG. 1;

FIG. 5 is a sectional view showing a sectional configuration of a thin film inductor of a first comparative example;

FIG. 6 is a sectional view showing a sectional configuration of a thin film inductor of a second comparative example;

FIG. 7 is a sectional view showing a modification in terms of the configuration of the thin film inductor of the present invention;

FIG. 8 is a sectional view showing other modification in terms of the configuration of the thin film inductor of the present invention;

FIG. 9 is a diagram showing the thickness ratio TB/TA dependence of an inductance Ldc;

FIG. 10 is a diagram showing the thickness ratio TB/TA dependence of an inductance L1M;

FIG. 11 is a diagram showing the thickness ratio TB/TA dependence of a resistance Rdc;

FIG. 12 is a diagram showing the thickness ratio TB/TA dependence of a resistance R1M; and

FIG. 13 is a diagram showing the thickness ratio TB/TA dependence of a Q value Q1M.

### DESCRIPTION OF THE PREFERRED EMBODIMENTS

Preferred embodiments of the present invention will now be described in detail with reference to the accompanying drawings.

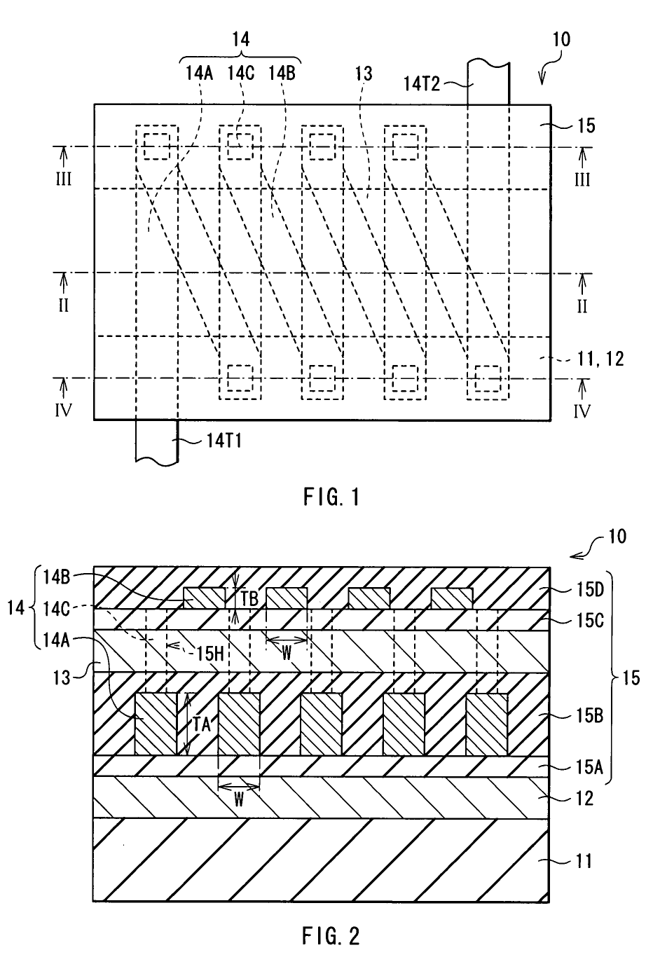

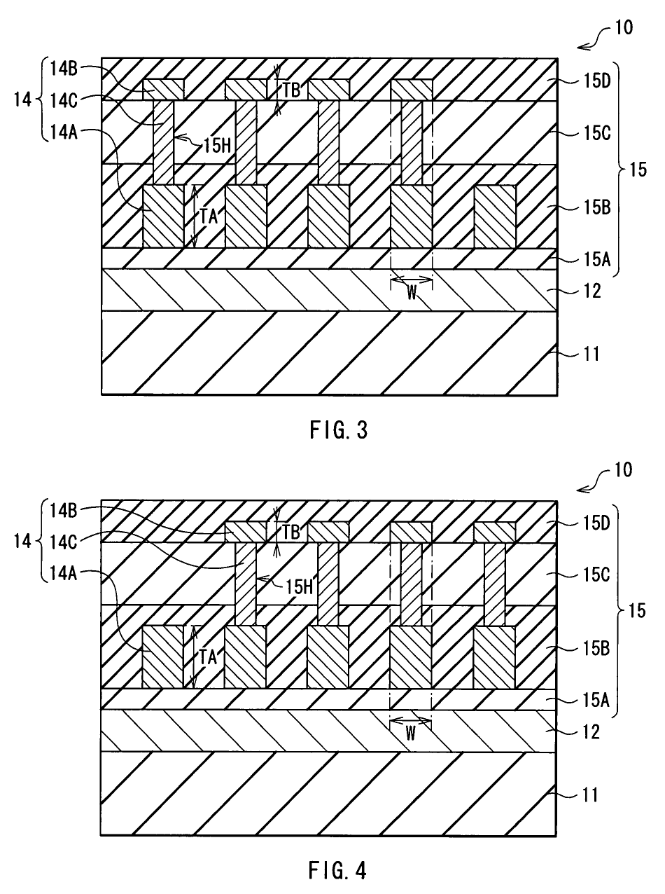

FIGS. 1 to 4 show the configuration of a thin film inductor 10 as an application of a thin film device according to an embodiment of the present invention. FIG. 1 shows the plan configuration thereof, and FIGS. 2 to 4 show the sectional configurations thereof taken along the line II-II, the line III-III, and the line IV-IV, respectively. In the following description, the side close to a substrate 11, and the side away from the substrate 11 are referred to as “lower” and “upper” sides, respectively.

In the thin film inductor 10, a lower magnetic film 12, and an upper magnetic film 13 and a thin film coil 14 buried with an insulating film 15, are stacked on a substrate 11, as shown in FIGS. 1 to 4. The lower magnetic film 12 and the upper magnetic film 13 are opposed to each other. The thin film coil 14 has a solenoid type structure wound on the upper magnetic film 13.

The substrate 11 supports the lower magnetic film 12, the upper magnetic film 13, and the thin film coil 14. The substrate 11 can be formed of, for example, glass, silicon (Si), aluminium oxide (Al₂O₃, being so-called alumina), ceramics, ferrite, semiconductor, or resin. The material of the substrate 11 is not limited to these materials, and other material may be used.

The lower magnetic film 12 and the upper magnetic film 13 are first and second magnetic films for increasing inductance, respectively, which can be formed of a conductive magnetic material such as cobalt (Co) alloy, iron (Fe) alloy, or nickel iron (NiFe) alloy. Examples of the cobalt alloy are cobalt zirconium tantalum (CoZrTa) alloy and cobalt zirconium niobium (CoZrNb) alloy.

The thin film coil 14 forms inductance between one end (a terminal 14T1) and the other end (a terminal 14T2), which can be formed of a conductive material such as copper (Cu). Although FIGS. 1 to 4 show the case where the number of turns of the thin film coil 14 is four turns, the number of turns thereof can be set arbitrarily.

In the thin film coil 14, a plurality of strip lower and upper coil portions 14A and 14B, and a plurality of cylindrical middle coil portions 14C are connected in series. The lower coil portions 14A are first coil portions arranged on a hierarchy (a lower hierarchy) between the lower magnetic film 12 and the upper magnetic film 13. The upper coil portions 14B are second coil portions arranged on a hierarchy (an upper hierarchy) on the side opposite the lower coil portions 14A, with the upper magnetic film 13 interposed therebetween. The upper coil portions 14B are arranged so as to overlap with one end or the other end of the upper coil portions 14A. For example, the lower coil portions 14A and the upper coil portions 14B are of rectangular cross section, and of equal width W. The middle coil portions 14C are third coil portions arranged on a hierarchy between the lower hierarchy and the upper hierarchy, and positioned at locations where the lower coil portions 14A and the upper coil portions 14B are overlapped with each other.

The thickness TA of the lower coil portions 14A is larger than the thickness of the upper coil portions 14B. That is, the ratio of the thickness TB to the thickness TA (the thickness ratio), namely TB/TA, is in the range of TB/TA<1. The thickness ratio TB/TA can be set arbitrarily. In particular, the range of 0.1<TB/TA<1 is preferred from the viewpoint of suppressing any increase in the direct current resistance of the thin film coil 14.

The insulating film 15 electrically isolates the thin film coil 14 from the lower magnetic film 12 and the upper magnetic film 13. The insulating film 15 can be formed of an insulating non-magnetic material such as silicon oxide (SiO₂), or an insulating resin material such as polyimide or photoresist. For example, the insulating film 15 includes: (i) a lower insulating film 15A disposed on the lower magnetic film 12; (ii) a lower coil insulating film 15B disposed on the lower insulating film 15A so as to bury the lower coil portions 14A; (iii) an upper insulating film 15C disposed on the lower coil insulating film 15B so as to bury the upper magnetic film 13; and (iv) an upper coil insulating film 15D disposed on the upper insulating film 15C so as to bury the upper coil portions 14B. In the lower coil insulating film 15B and the upper insulating film 15C, contact holes 15H are provided at every location where the lower coil portions 14A and the upper coil portions 14B are overlapped with each other, and a middle coil portion 14C is buried in each of the contact holes 15H. The materials of the insulating films 15A to 15D are not necessarily the same, and they may be different from each other.

The thin film inductor 10 as the thin film device according to the present embodiment includes the thin film coil 14 of solenoid type wound on the upper magnetic film 13. The thickness TA of the lower coil portions 14A in between the lower magnetic film 12 and the upper magnetic film 13 is larger than the thickness TB of the upper coil portions 14B not in between the films 12 and 13 (the thickness ratio TB/TA<1). This enables the Q value to be improved. The reason for this is as follows.

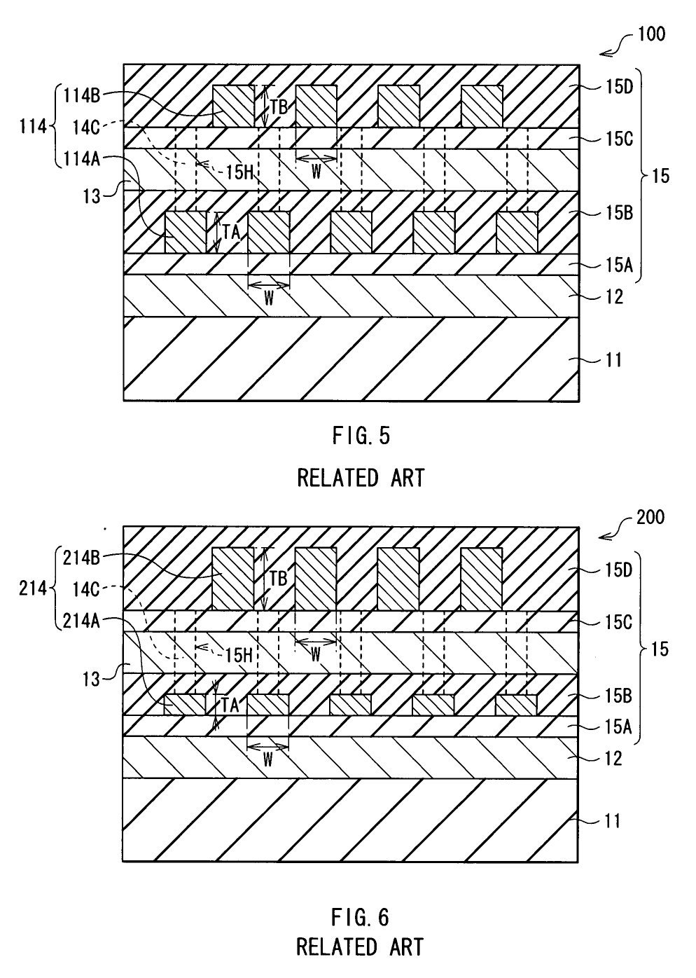

FIGS. 5 and 6 show the configurations of thin film inductors 100 and 200 of first and second comparative examples, respectively, each of which shows the sectional configuration corresponding to that in FIG. 2. The thin film inductors 100 and 200 have the same configuration as the thin film inductor 10, except that a thin film coil 114 (lower coil portions 114A and upper coil portions 114B) and a thin film coil 214 (lower coil portions 214a and upper coil portions 214B) are provided instead of the thin film coil 14. The thin film coil 114 have the same configuration as the thin film coil 14, except that the thickness TA of the lower coil portions 114A is equal to the thickness of the upper coil portions 114B (the thickness ratio TB/TA=1). On the other hand, the thin film coil 214 has the same configuration as the thin film coil 14, except that the thickness TA of the lower coil portions 214A is smaller than the thickness of the upper coil portions 214B (the thickness ratio TB/TA>1). The sum of the thickness TA and the thickness TB is constant in the thin film inductors 10, 100, and 200.

In the thin film inductor 100 of the first comparative example, the lower magnetic film 12 and the upper magnetic film 13 having sandwiched therebetween the lower coil portions 114A are too close to each other, thereby increasing the tendency that magnetic flux is confined therebetween. This increases the amount of crossover magnetic flux interlinking the lower coil portions 114A, so that alternating current resistance R is increased in the thin film coil 114. It is therefore difficult for the first comparative example to improve the Q value.

In the thin film inductor 200 of the second comparative example, the lower magnetic film 12 and the upper magnetic film 13 are further closer to each other than in the first comparative example. This further increases the amount of crossover magnetic flux interlinking the lower coil portions 214A, so that alternating current resistance R is further increased in the thin film coil 214. Hence, it is also difficult for the second comparative example to improve the Q value.

In contrast, in the thin film inductor 10 of the present embodiment, the lower magnetic film 12 and the upper magnetic film 13 are sufficiently spaced apart, thereby reducing the tendency that magnetic flux is confined therebetween. Consequently, the amount of crossover magnetic flux interlinking the lower coil portions 14A can be reduced than the cases of the first and second comparative examples, so that alternating current resistance R can be lowered in the thin film coil 14. Hence, the present embodiment enables the Q value to be improved when employing the thin film coil 14 of solenoid type. Specifically, the Q value can be increased as the thickness TA is increased relative to the thickness TB, that is, as the thickness ratio TB/TA is decreased.

Particularly in the present embodiment, by setting the thickness ratio TB/TA to the range of 0.1<TB/TA<1, a sufficient Q value can be obtained while suppressing any excessive increase in the direct current resistance of the thin film coil 14.

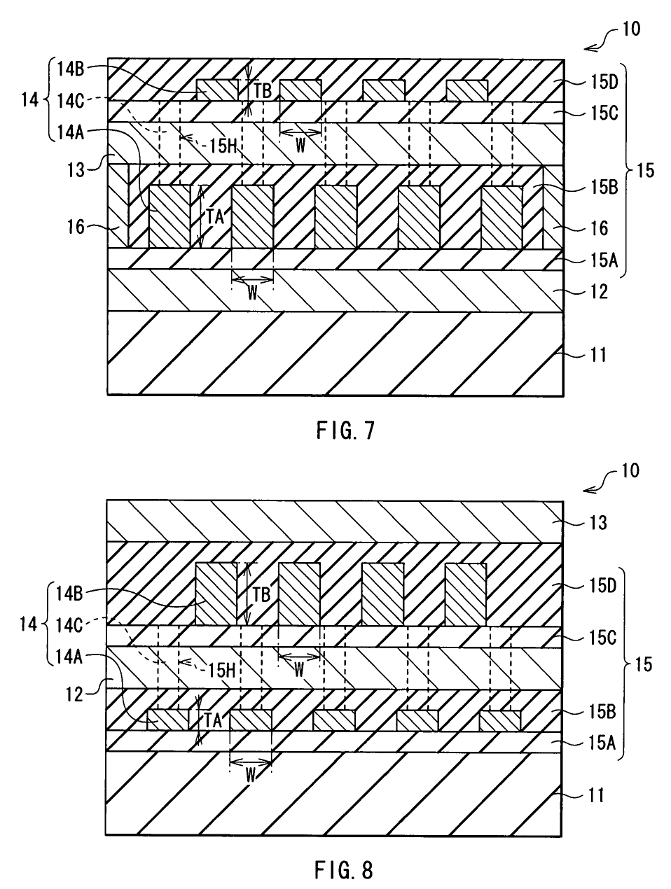

In the present embodiment, as shown in FIG. 2, the lower magnetic film 12 and the upper magnetic film 13 are spaced apart, without limiting to this. For example, as shown in FIG. 7 corresponding to FIG. 2, the lower magnetic film 12 and the upper magnetic film 13 may be connected to each other. FIG. 7 shows the case where a connecting part 16 is interposed between the lower magnetic film 12 and the upper magnetic film 13, and the connecting part 16 establishes connections between one end of the film 12 and one end of the film 13, and between the other end of the film 12 and the other end of the film 13. The magnetic material of the connecting part 16 may be the same as or different from that of the lower magnetic film 12 and the upper magnetic film 13. In this case, the magnetic path structure becomes a closed magnetic path thereby to increase the inductance L. This further improves the Q value.

Further in the present embodiment, as shown in FIG. 2, the lower magnetic film 12 and the upper magnetic film 13 are arranged so as to sandwich therebetween the lower coil portions 14A, so that the thickness TA of the lower coil portions 14A is larger than the thickness TB of the upper coil portions 14B. Without limiting to this, for example, as shown in FIG. 8 corresponding to FIG. 2, in the case where the lower magnetic film 12 and the upper magnetic film 13 are arranged so as to sandwich therebetween the upper coil portions 14B, instead of the lower coil portions 14A, by replacing the upper magnetic film 13 with the lower magnetic film 12, and disposing the upper magnetic film 13 on the upper coil insulating film 15D, the thickness TB of the upper coil portions 14A may be larger than the thickness TA of the lower coil portions 14A. This also achieves the same effect as in the case shown in FIG. 2, thus enabling the Q value to be improved.

Although in the present embodiment, the configuration of the thin film coil 14 is shown in FIGS. 1 to 4, the relative positional relationship (the range of overlapping) between the lower coil portions 14A and the upper coil portions 14B, or the direction to extend the terminals 14T1 and 14T2, or the like can be set arbitrarily, without limiting to that shown in FIGS. 1 to 4.

### EXAMPLES

Examples of the present invention will be described below.

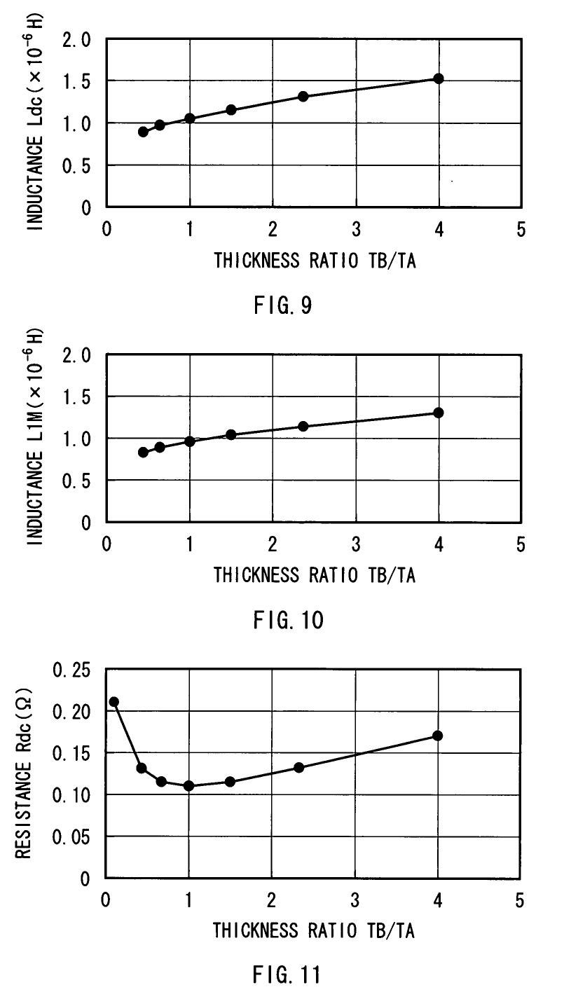

Various performances of the thin film inductors provided with the thin film coil of solenoid type as shown in FIGS. 1 to 6 were estimated by magnetic field analysis using finite element method. The results are shown in FIGS. 9 to 13. FIGS. 9 to 12 show inductance Ldc (×10⁻⁶H), inductance L1M (×10⁻⁶H), resistance Rdc (Ω), and thickness ratio TB/TA dependence of resistance R1M (Ω), respectively. FIG. 13 shows thickness ratio TB/TA dependence of A value Q1M (Ω). The above-mentioned “inductance Ldc” and “resistance Rdc” were values found from magnetostatic field analysis, and can generally be approximated with an analysis value in low frequency regions in the order of kHz. On the other hand, the above-mentioned “inductance L1M”, “resistance R1M” and “Q value Q1M” were values when the frequency is 1 MHz.

When estimating the various performances of the thin film inductors, a series of parameters were set as follows. That is, with respect to the thin film coil, the line width was 100 μm, the line space was 20 μm, the number of turns was 16 turns, the gap was 5 μm, and the sum of the thickness TA of the lower coil portions and the thickness TB of the upper coil portions was 200 μm. The thickness ratio TB/TA was changed through the following seven stages: 0.1 (18 μm/182 μm), 0.43 (60 μm/140 μm), 0.67 (80 μm/120 μm), 1 (100 μm/100 μm), 1.5 (120 μm/80 μm), 2.33 (140 μm/60 μm), and 4 (160 μm/40 μm). The thickness ratio TB/TA<1 (TB/TA=0.1, 0.43, and 0.67) corresponded to the present invention shown in FIGS. 1 to 4, TB/TA=1 corresponded to the first comparative example shown in FIG. 5, and TB/TA>1 (TB/TA=1.5, 2.33, and 4) corresponded to the second comparative example shown in FIG. 6. With respect to the lower magnetic film and the upper magnetic film, the thickness was 10 μm, the permeability p was 2000, and the electric resistivity was 100 μΩcm. In FIGS. 9 to 13, the thickness ratio TB/TA was changed through the above-mentioned seven stages (including the stage of TB/TA=0.1) in FIG. 11, and the thickness ratio TB/TA was changed through the six stages (excluding the stage of TB/TA=0.1) in FIGS. 9, 10, 12, and 13.

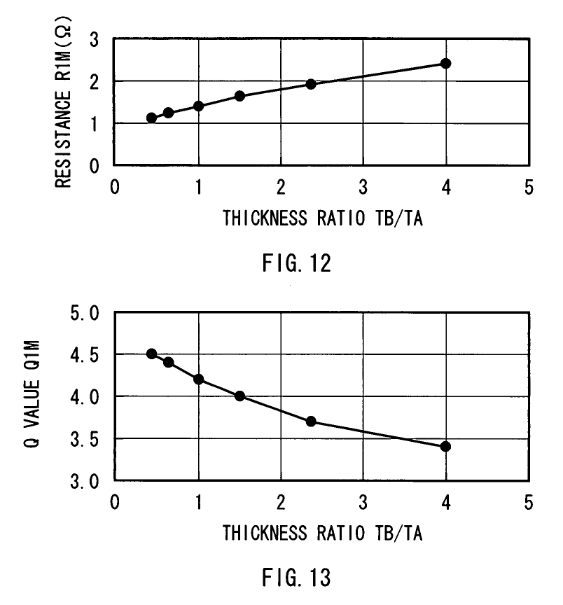

As shown in FIGS. 9 and 10, the inductances Ldc and L1M were gradually increased as the thickness ratio TB/TA was increased. As shown in FIGS. 11 and 12, the resistance Rdc drew a downward convex curve with the thickness ratio TB/TA=1 as the vertex, and the resistance R1M was gradually increased as the thickness ratio TB/TA was increased.

From the results shown in FIGS. 10 and 12, as shown in FIG. 13, the Q value Q1M, which indicates the coil performance during the operation of the thin film inductor, was gradually increased as the thickness ratio TB/TA was decreased. That is, the Q value Q1M was larger in the present invention having the thickness ratio in the range of TB/TA<1, than the first and second comparative examples having the thickness ratio in the range of TB/TA≧1. From this, it was confirmed that the thin film conductor of the present invention is capable of improving the Q value by increasing the thickness TA of the lower coil portions than the thickness TB of the upper coil portions, when employing the thin film coil of solenoid type.

In the range of TB/TA<1, particularly, the resistance Rdc was remarkably increased when TB/TA=0.1, as shown in FIG. 11. From this, along with the results shown in FIG. 11, it was confirmed that the thin film inductor of the present invention is capable of attaining a sufficient Q value, while suppressing any excessive increase in the direct current resistance of the thin film coil, by setting the thickness ratio TB/TA to the range of 0.1<TB/TA<1.

While the present invention has been described through the embodiment and the examples, the present invention is not limited to the forms described in the foregoing embodiment and examples, and various modifications can be made. Specifically, although the foregoing embodiment and examples have described the case where the thin film device of the present invention is applied to the thin film inductor, without limiting to this, the present invention may be applied to other devices other than the thin film inductor. Examples of the “other devices” are thin film transformers, thin film magnetic sensors, or MEMS (micro electro mechanical systems), as well as filters or modules including a thin film inductor, a thin film transformer, a thin film magnetic sensor, or MEMS. The applications of the thin film device of the present invention to these other devices also provide the same effect as in the embodiment and the examples.

The thin film device according to the present invention is applicable to thin film inductors, thin film transformers, thin film magnetic sensors, or MEMS, as well as filters or modules including these.

It should be understood by those skilled in the art that various modifications, combinations, sub-combinations and alterations may occur depending on design requirements and other factors insofar as they are within the scope of the appended claims or the equivalents thereof.

What is claimed is:

1. A thin film device having a first magnetic film and a second magnetic film oppositely disposed to each other, and a thin film coil wound on the second magnetic film, wherein
the thin film coil includes a plurality of first coil portions arranged between the first and the second magnetic films, a plurality of second coil portions arranged on a side opposite the first coil portions, with the second magnetic film interposed therebetween, and a plurality of third coil portions connecting the first and the second coil portions so that the first, second and third coil portions are combined together in series; and
the first coil portions have a larger thickness than the second coil portions.

2. The thin film device according to claim 1, wherein
one end or the other end in the longitudinal direction of the second coil portion is located so as to overlap with one end or the other end in the longitudinal direction of the first coil portion, and
the third coil portion is arranged in a position where the second coil portion overlaps with the first coil portion.

3. The thin film device according to claim 1, wherein a ratio of a thickness TB of the second coil portions to a thickness TA of the first coil portions, namely TB/TA, is in a range of: 0.1<TB/TA<1.
